(19) United States
(12) Patent Application Publication
(10) Pub. No.: US 2011/0156436 A1
(43) Pub. Date: Jun. 30, 2011

(54) Armor car cover

(76) Inventor: Debra An Eggeman-Steffen, El Cajon, CA (US)

(21) Appl. No.: 12/930,195

(22) Filed: Dec. 31, 2010

Related U.S. Application Data
(60) Provisional application No. 61/335,078, filed on Dec. 31, 2009.

(51) Int. Cl. B60J 11/04

(52) U.S. Cl. 296/136.01

(57) ABSTRACT

The Armor Car Cover provides a specially designed protective covering, configured specifically to be anchored to the vehicle tires, thus ensuring that the cover remains securely in place over the vehicle, regardless of wind activity. The tire covers additionally comprise a strip of hook and loop fastener, such as Velcro™, encircling the tire and an adjustable belt that fastens to the lower part of the tire to keep the tire covering portion in place. Comprised primarily of heavy duty UV treated vinyl or canvas material, the same material utilized in the manufacture of convertible car roofs, the Armor Car Cover is similar in appearance to traditional vehicle covers and can be produced in a myriad of sizes and shapes to fit the various makes and models cars, vans and trucks on the road. The covering encompasses the entire body of the vehicle, as well as expands downward over each tire, covering the wheel and rim completely. The portions encircling the tire further comprise an adjustable belt to secure the covering around the tire. The tire covering portion further comprises an integral pocket to store the adjustable belts when not in use.

### CLAIM OF PRIORITY

This patent application claims priority under 35 USC 119(e)(1) from U.S. Provisional Patent Application Ser. No. 61/335,078 filed Dec. 31, 2009, of common inventorship herewith entitled, “The Armor Car Cover.”

### FIELD OF THE INVENTION

The present invention pertains to the field of protective covers and more specifically to protective covers for automobiles.

### BACKGROUND OF THE INVENTION

The prior art has put forth multiple designs for protective coverings for automobiles. Among these are:

U.S. Pat. No. 4,355,839 to Jack S. Rosen describes a theft deterrent device for car covers comprising a flap which closes into the door of the vehicle.

U.S. Pat. No. 4,795,207 to Edwin B. Clarke describes a vehicle cover for small trucks comprising an elastic band which helps to hold the cover to the vehicle.

U.S. Pat. No. 5,056,839 to Yi C. Yoon describes an automobile cover assembly comprising a case and rotary shaft.

None of these prior art references describe the present invention.

### SUMMARY OF THE INVENTION

It is an object of the present invention to provide an improved cover for an automobile.

### BRIEF DESCRIPTION OF THE DRAWINGS

FIG. 1 shows the locking belt with adjustment strap mounting the cover onto the front right end of an automobile.

FIG. 2 is a perspective view showing a corner strap of the car cover of the present invention.

FIG. 3 shows the wool interior of the car cover of the present invention.

FIG. 4 shows the optional antenna guard of the car cover of the present invention.

FIG. 5 is a front perspective view of the car cover of the present invention mounted on a car.

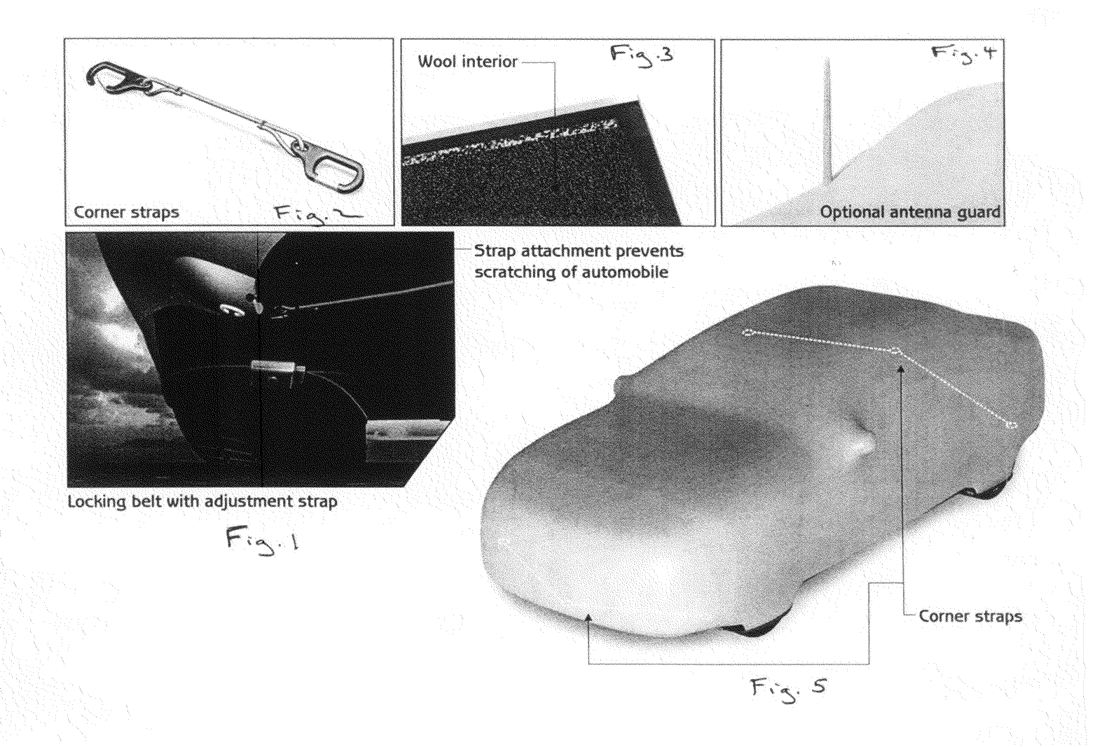

### DETAILED DESCRIPTION OF THE INVENTION

An automobile is a valuable and practical investment, and consumers regularly undergo simple steps to ensure the long life and smooth operation of their vehicle. Regularly changing the engine oil, checking the pressure and making sure that the brake and power steering fluid are at appropriate levels, are but a few key tasks involved in routine car maintenance. Perhaps one of the most simple and surprisingly important steps one can take to care for their automobile is to park their car in a garage or sheltered area between uses. For the countless consumers who live in homes, condominiums and apartments which lack garages or carports, a simple car cover is an invaluable commodity which can protect their vehicle's delicate finish. Preventing the accumulation of harmful residue which results from excessive exposure to rain, mud, snow, sleet and salt, the use of car covers is especially important during rainy or snowy weather, as even the lightest rain or snow shower can leave behind a thin film of acid which can quickly eat away at the vehicle's paint and topcoat.

Although there is little dispute that utilizing a car cover provides vehicle owners a simple means of protecting their vehicle from exposure to the elements, a car cover does little good if it is not secured in place. Specifically, traditional fabric car covers are secured about the vehicle's undercarriage and bumpers by way of elastic banding which runs the perimeter of the cover. While these covers may be sufficient during normal weather, their lightweight design and simple application can render these covers easily susceptible to strong winds. As such, many frustrated car owners have stepped out onto their driveway in the morning, only to find that the car cover which was carefully applied the night before has blown partially or completely off the vehicle, thus rendering the vehicle exposed to the elements.

The present invention, hereinafter referred to as the Armor Car Cover, provides a unique invention which offers consumers who lack garages or carports a secure alternative to traditional car covers and one which will withstand strong winds, remaining securely in place until removed by the vehicle owner. Simply stated, the Armor Car Cover is a specially designed protective covering, configured specifically to be anchored to the vehicle tires, thus ensuring that the cover remains securely in place over the car, regardless of wind activity. A flap covers the hole on the inside to protect the finish of the car. The tire covers additionally comprise a strip of hook and loop fastener, such as Velcro™, encircling the tire and an adjustable belt that fastens to the lower part of the tire to keep the tire covering portion in place. Any suitable material is useful for the outside of present invention, such as a light, breathable material which is impervious to ultraviolet radiation, insulating and waterproof on the outside is acceptable. Examples include heavy duty UV treated vinyl or canvas material, the soma material utilized in the manufacture of convertible car roofs. The inside lining can be comprised of any suitable soft material which will protect the finish of the vehicle. The Armor Car Cover is similar in appearance to traditional vehicle covers and can be produced in a myriad of sizes and shapes to fit the various makes and models cars, vans and trucks on the road as well as RVs and motor homes.

Notably, this unique covering encompasses the entire body of the vehicle, as well as expands downward over each tire, covering the wheel and rim completely. The portions encircling the tire further comprise an adjustable belt to secure the covering around the tire. The tire covering portion further comprises an integral pocket to store the adjustable belts when not in use wherein the pocket is located on the inner side of the covering. The pocket can be equipped with hook and loop fasteners to help keep the adjustable belts secure.

A circular shaped opening boasting a reinforced grommet fastener is positioned on the front or back of the unit to accommodate the existing vehicle antenna. To protect the delicate vehicle finish, the underside of the Armor Car Cover features a soft wool or comparable synthetic lining.

One novel aspect of the Armor Car Cover however, is found in the method by which this covering is secured over the vehicle. Running the perimeter of the base of cover is a stretchy elastic banding, similar to that found on standard car covers and designed to snugly grip the underside of the vehicle bumpers and undercarriage. There will also be an overhang of approximately two inches at the bottom of the car cover to ensure proper water runoff. Most notably, the Armor Car Cover also boasts a system of anchorage tethers which enable the user to secure the covering in place over each tire, thus preventing the cover from being blown or lifted by strong winds, while simultaneously ensuring the wheel and hub cap also remain covered at all times.

Additional features include appropriately positioned on each side of the covering, two sets of corresponding, adjustable belt closures designed to be wrapped around and secured behind each vehicle tire. These fasteners boast simple male tongue connectors to be inserted into the corresponding female buckle receptacles, thus enabling the user to effortlessly secure the buckle in place. These fasteners are adjustable in length to accommodate any size tires, rims or mag wheels. A simple release button is positioned on the top of each buckle receptacle for use in easily releasing the buckles and removing the covering from the vehicle following use. There are two fasteners, one on each side of the vehicle which can be locked with any means such as a key, or combination lock, for example. The Armor Car Cover can be produced in a variety of vibrant colors, as well as a host of neutral hues.

Application and use of the Armor Car Cover is very simple and straight forward. First, the user purchases an Armor Car Cover sized appropriately for the make and model of their vehicle. Next, according to easily followed package instructions, the user installs the unit over their vehicles, securing the covering in place by way of the elastic banding and integrated, adjustable buckle tethers. Once installed, the Armor Car Cover provides an impenetrable and secure barrier between the vehicle and external elements. After use, the user simply removes the unit from their vehicle, storing the Armor Car Cover in the vehicle trunk or a storage closet until again needed.

The Armor Car Cover is a cleverly designed invention which provides consumers a number of significant benefits and advantages. Foremost, the Armor Car Cover offers consumers a simple and efficient means of protecting their parked vehicle from exposure to the elements, by ensuring the covering remained securely in place once installed. A practical alternative to traditional car covers which can be easily lifted and blown off a vehicle due to strong winds, the Armor Car Cover remains securely tethered to the vehicle, regardless of wind activity. Boasting four sets of corresponding buckle fasteners with which to anchor the cover over each tire, as well as a stretchy elastic banding which hugs the underside of the vehicle bumpers and undercarriage, the Armor Car Cover remains secure and sound, even on the gustiest of afternoons or evenings.

Protecting the grille, hood, roof, doors and trunk, as well as the tires and rims from exposure to the elements, use of the Armor Car Cover ensures that the vehicle's body remained smooth and unfettered by rain, snow, sleet or small diameter hail damage. Further, the softly lined Armor Car Cover ensures that the fragile paint and top coat remained pristine and clean, regardless of detrimental weather conditions. Serving to repel pounding rain, icy snow, and sleet, use of the Armor Car Cover effectively eliminates the need for repeated trips to the car wash, simply in order to maintain the appearance of one's vehicle and thus ensure that parked cars stayed cleaner, longer.

The Armor Car Cover also proves ideal for use during the summer months, when intense heat and the beating rays of the sun can cause the vehicle's exterior paint and interior to fade and fray. Because of these important advantages, use of the Armor Car Cover effectively extends the life of the vehicle.

Consumers who live in apartments or condominiums, as well as those who simply lack space in their garage to park their vehicle, will especially appreciate this useful product. Enabling these consumers to park their car beneath a fully functioning, yet portable covering, the Armor Car Cover proves an invaluable accessory for any car owner. Manufactured in a variety of sizes appropriate for the various makes and models cars, trucks and sport utility vehicles on the road, there is an Armor Car Cover to meet the needs of virtually any automobile owner. Durably constructed of quality materials, this product will withstand years of continual use.

The Armor Car Cover is an innovative invention which offers consumers a practical means of shielding their vehicle from the elements, while remaining firmly anchored in place at all times. Providing a simple way in which to care for one's investment, this cleverly designed invention proves an invaluable commodity for any automobile owner.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An improved vehicle cover, comprising a protective covering, configured specifically to be anchored to the vehicle tires, thus ensuring that the cover remains securely in place over the vehicle, wherein the covering encompasses the entire body of the vehicle, having an expansible portion to cover each tire completely covering the tire, wheel and rim.

2. The covering of claim 1 further comprising a circular shaped opening comprising a reinforced grommet fastener positioned on the front or back of the covering to accommodate the existing vehicle antenna.

3. The covering of claim 1 further comprising a soft wool or comparable synthetic lining to protect the delicate vehicle finish.

4. The covering of claim 1 further comprising an elastic or stretchable banding along the perimeter of the base of the covering to secure the covering over the vehicle.

5. The covering of claim 1 further comprising a system of anchorage tethers for securing the covering in place over each tire.

6. The covering of claim 1 further comprising two sets of corresponding, adjustable belt closures designed to be wrapped around and secured behind each vehicle tire.

7. The covering of claim 6 wherein the fasteners comprise male tongue connectors to be inserted into the corresponding female buckle receptacles, thus enabling the user to effortlessly secure the buckle in place, further comprising a release button positioned on the top of each buckle receptacle for use in easily releasing the buckles and removing the covering from the vehicle following use.

8. The covering of claim 1 comprised of heavy duty UV treated vinyl or canvas material.
